(19) United States
(12) Patent Application Publication
(10) Pub. No.: US 2020/0258170 A1
(43) Pub. Date: Aug. 13, 2020

(54) SYSTEMS AND METHODS FOR TRAVEL PLANNING USING CALENDAR ENTRIES

(71) Applicant: Travel Labs, Inc., Minneapolis, MN (US)

(72) Inventors: Parker W. SCHLANK, Lakeville, MN (US); Brandon D. BOKINSKIE, Brooklyn Park, MN (US); Zulfikar ALI, Savage, MN (US)

(73) Assignee: Travel Labs, Inc., Minneapolis, MN (US)

(21) Appl. No.: 16/273,914

(22) Filed: Feb. 12, 2019

(51) Int. Cl. G06Q 50/14; G06Q 10/02

(52) U.S. Cl. CPC G06Q 50/14; G06Q 10/025

(57) ABSTRACT

Systems and methods for searching for and/or booking travel services, such as air transportation, overnight accommodations, ground transportation, and/or other travel services. In particular, the present disclosure relates to systems and methods for searching for and/or booking travel based on a user's digital calendar entries. As a particular example, where a user creates a calendar entry using a calendaring application on a user device, such as a smartphone, systems and methods of the present disclosure may be configured to evaluate the calendar entry, determine whether travel services may be needed, and build a curated travel itinerary comprising suitable travel services to meet the user's needs for the calendar entry. The travel services may be selected based on travel parameters extracted from the calendar entry, user preferences, and/or user priorities.

### FIELD OF THE INVENTION

The present disclosure relates to novel and advantageous systems and methods for booking travel services. Particularly, the present disclosure relates to novel and advantageous systems and methods for building a travel itinerary based on a user's calendar entries.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Whether traveling for business or leisure, searching for and booking travel services is typically a time-consuming and laborious process. To find a desired price and/or desired options, an individual may be required to search on multiple service provider websites, travel websites, and/or other sources. The individual may thus be required to input the same search parameters and filters multiple times to search the various sources. Additionally, a traveler's company may place particular restrictions or budget limitations on business travel that may make it even more difficult to find suitable air transportation, overnight accommodations, ground transportation, and/or other travel services. While some travelers, particularly some business travelers, can delegate the task of searching for and booking travel services to an assistant, many travelers do not have this option.

Thus, there is a need in the art for improved systems and methods to facilitate booking travel services.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for providing a curated travel itinerary. The method may include receiving a calendar entry for a user, the calendar entry comprising a location, date, a start time, and an end time. The method may further include determining whether the calendar entry relates to travel by comparing the location to a user location. Additionally, the method may include extracting one or more travel parameters from the calendar entry, the one or more travel parameters comprising arrival date, arrival time, departure date, departure time, and/or location. In some embodiments, the method may include searching a travel provider database using the one or more travel parameters, the travel provider database comprising searchable booking options for at least one travel service provider, and selecting at least one booking option from the travel provider database to build a curated travel itinerary for the calendar entry. In some embodiments, the travel parameters may be modified to reflect at least one stored user preference. A weight may be applied to one or more travel parameters based on at least one stored user priority. Additionally, the method may include presenting the curated travel itinerary to the user via a user interface. In some embodiments, a plurality of curated travel itineraries for the calendar entry may be built for the user's selection. The method may include receiving the user's selection of a preferred travel itinerary and automatically booking the travel services included in the travel itinerary. Moreover, the method may include updating a stored user preference or a stored user priority based on the user's selection of a preferred travel itinerary. The user location may be a stored location of a current geolocation of the user. Extracting one or more travel parameters from the calendar entry may include determining whether the calendar entry includes an overnight stay. The at least one travel service provider may include an air transportation company, overnight accommodation company, or ground transportation company. Additionally, the method may include booking the at least one booking option of the curated travel itinerary using stored identity information and stored payment information for the user.

The present disclosure, in one or more embodiments, additionally relates to a system for providing a curated travel itinerary. The system may include a database storing, as non-transferable computer readable storage media, at least one user travel preference. The system may further include a controller communicably coupled to the database, the controller having a calendar module and a travel itinerary module. The calendar module may be configured for receiving calendar entries from a calendaring application, and upon receiving a calendar entry, the calendar module may determine whether the calendar entry relates to travel by comparing a location associated with the calendar entry to a user location. The calendar module may further extract one or more travel parameters from the calendar entry, the one or more travel parameters including an arrival date, arrival time, departure date, departure time, and/or a location. The travel itinerary module may be configured for developing a curated travel itinerary based on the one or more travel parameters, wherein upon receiving the one or more travel parameters from the calendar module, the travel itinerary module searches a communicably coupled travel provider database using the one or more travel parameters and the at least one user travel preference, the travel provider database including searchable booking options for at least one service provider. The travel itinerary module may further select at least one booking option from the travel provider database to build a curated travel itinerary for the calendar entry. The database may additionally store, as non-transferable computer readable storage media, at least one user priority and the travel itinerary module may search the communicably coupled travel provider database using the one or more travel parameters, the at least one travel preference, and the at least one user priority. The user priority may relate to travel cost in some embodiments. The database may additionally store, as non-transferable computer readable storage media, user identity information and user payment information, and the controller may include a booking module configured to book the at least one booking option of the curated travel itinerary using the stored identity information and stored payment information. In some embodiments, the system may further include a user interface accessible via a user device and the travel itinerary module may present the curated travel itinerary to the user via the user interface.

The present disclosure, in one or more embodiments, additionally relates to a computer readable storage medium encoded with instructions that, when executed by a computer processor, cause the computer to, upon receiving a calendar entry including a location, date, and time, determine whether the calendar entry relates to travel by comparing the location to a user location. The instructions may further cause the computer to extract one or more travel parameters from the calendar entry, such as an arrival date, arrival time, departure date, departure time and location. The instructions may cause the computer to search a travel provider database using the one or more travel parameters, the travel provider database including searchable booking options for at least one travel service provider. The instructions may further cause the computer to select at least one booking option from the travel service provider database to build a curated itinerary for the calendar entry. In some embodiments, the instructions may cause the computer to modify the travel parameters to reflect at least one stored user preference. The instructions may cause the computer to apply a weight to one or more travel parameters based on at least one stored user priority. In some embodiments, the instructions may cause the computer to present the curated travel itinerary to the user via a user interface.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a diagram of a system of the present disclosure, according to one or more embodiments.

FIG. 2A is a flow diagram of a method of the present disclosure, according to one or more embodiments.

FIG. 2B is a flow diagram of another method of the present disclosure, according to one or more embodiments.

FIG. 3 is a data flow diagram for a system of the present disclosure, according to one or more embodiments.

### DETAILED DESCRIPTION

The present disclosure relates to novel and advantageous systems and methods for searching for and/or booking travel services, such as air transportation, overnight accommodations, ground transportation, and/or other travel services. In particular, the present disclosure relates to systems and methods for curating travel itineraries and booking travel services based on a user's digital calendar entries. As a particular example, where a user creates a calendar entry for a meeting using a calendaring application on a user device, such as a smartphone, systems and methods of the present disclosure may be configured to evaluate the calendar entry to determine whether travel services will be needed to attend the meeting, search for applicable travel services, and build a curated travel itinerary to meet the user's needs and preferences for attending the meeting. Such travel services may include air transportation, overnight accommodations, ground transportation, and/or other travel services. Based on the curated travel itinerary, the user may have the option to book the recommended travel services. In this way, systems and methods of the present disclosure may significantly reduce a user's time and effort in scheduling travel services. Whereas a user may conventionally be required to enter travel parameters into several service provider website and/or travel websites, for example, systems and methods of the present disclosure may automatically present a user with a curated travel itinerary based on the user's upcoming travel needs and unique preferences.

As used herein, “travel service(s)” may include air transportation, overnight accommodations, ground transportation, and/or other travel services. Air transportation may include commercial flights, private flights, chartered flights, and may include airplanes, helicopters, drones, and/or other airborne vehicles or crafts. Overnight accommodations may include hotels, motels, hostels, bed and breakfasts, short-term and long-term home or apartment rentals (e.g., AirBNB or homeaway.com), timeshares, and/or other overnight accommodations. Ground transportation may include rails, trains, light rails, buses, long-term or short-term rental cars (including traditional rental car services such as Enterprise, as well as car sharing services such as Turo and Zipcar), limousines, black car services, taxis, rideshare services (e.g., Uber or Lyft), autonomous cars, ferries, boats, public transportation, rickshaws, bicycles (including electric, standard, and mopeds, for example), scooters (including electric and standard), subways, and/or other modes of ground transportation. Still other travel services are contemplated as well. Moreover, while examples herein may be described with respect to air travel, it is to be appreciated that systems and methods of the present disclosure may be appropriate for rail travel, bus travel, boat travel, and/or other modes of air, land, or sea transportation.

Systems and methods of the present disclosure may be configured for evaluating a user's calendar entries to determine whether the user has an upcoming trip or is otherwise in need of travel services. For example, where a user creates a unique calendar entry for an upcoming meeting via the user's smartphone, tablet, smart watch, notebook or desktop computer, or other computing device, systems and methods of the present disclosure may be configured to evaluate data associated with the calendar entry to determine whether the user's attendance at the meeting requires travel services, such as air transportation, overnight accommodations, ground transportation, and/or other travel services. For example, if the meeting is scheduled at a location that is outside of the user's current city or state, it may be determined that the meeting requires the user to travel. In some embodiments, this may be determined automatically, and in other embodiments, a user may expressly indicate whether travel services will be needed for the meeting or other event. Systems and methods of the present disclosure may determine travel parameters based on the user's calendar entry, such as dates of travel, destination, and other parameters. Such travel parameters may be combined, or modified based on, stored user preferences. As a particular example, a user may prefer early morning flights or non-stop flights. As another example, a user may prefer a particular hotel brand or rental car company. Travel parameters and user preferences may be used to automatically search one or more travel provider databases to find suitable air transportation, overnight accommodations, ground transportation, and/or other travel services. From the travel provider databases, one or more travel services may be selected and suggested or recommended to the user in the form of a curated itinerary. Additionally, in some embodiments, the systems and methods of the present disclosure may be configured to book, or facilitate booking, the travel services.

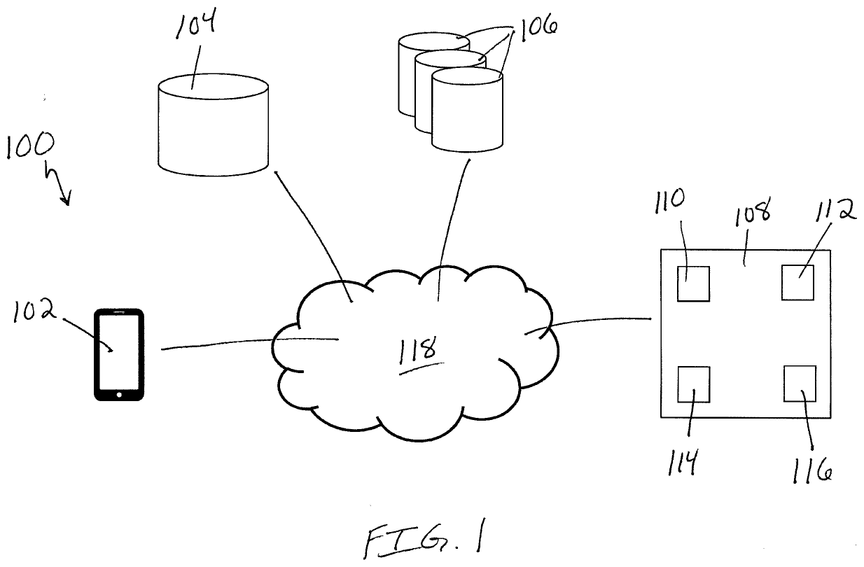

Turning now to FIG. 1, a system 100 for booking travel is shown, according to one or more embodiments. The system 100 may be configured for suggesting, recommending, and/or booking air transportation, overnight accommodations, ground transportation, and/or other travel services. The system 100 may suggest, recommend, and/or book such travel services based on a user's planned trips as determined from the user's calendar entries. For example, where a user creates a calendar entry for a meeting, the system 100 may examine the calendar entry to determine whether the meeting is scheduled to take place at or near the user's current location, home location, office location, or in another location. Where the system 100 determines that the meeting, or other event, is to occur in a distant location, the system may determine travel parameters such as destination and dates of travel. The system 100 may additionally consider user preferences, such as the user's preferred hotels and airlines, preferred flight times, and others. Based on the travel parameters and user preferences, the system 100 may access one or more databases for travel providers, such as for airlines, hotels, and rental car or other ground transportation companies, to find suggested or recommended travel services. The system 100 may recommend or suggest the travel services to the user via a user interface, and in some embodiments, the system may book or facilitate booking one or more travel services.

As shown in FIG. 1, the system 100 may generally include a user device 102, a database 104, one or more travel provider databases 106, and a controller 108 configured to manage user data, evaluate calendar entries, determine travel parameters, search travel provider databases based on travel parameters and user preferences, and suggest, recommend, and/or book travel services. In particular, the controller 108 may include a user profile module 110, a calendar module 112, a travel itinerary module 114, and a booking module 116. In other embodiments, the controller 108 may include additional and/or alternative modules or other components. Each of the components of the system 100 may be communicable coupled over one or more wired or wireless networks 118.

The user device 102 may be or include a smartphone, smart watch, tablet computer, notebook computer, desktop computer, or other personal computing device. The user device 102 may allow a user to access a user interface for inputting user data such as profile information and travel preferences, viewing travel recommendations, and selecting a travel itinerary. The user interface, described in more detail below, may be or include a program, application, or web-based interface. The user device 102 may further include a calendaring program or application. For example, the user device 102 may include software for providing Google Calendar, Apple Calendar, Microsoft Outlook, and/or other calendaring programs through which a user may create unique calendar entries for upcoming meetings and other events. The calendaring application may allow a user to input a location and time for a calendar entry. The user device 102 may be communicably coupled to each of the database 104, travel provider databases 106, and controller 108.

The database 104 may include one or more local or remote data storage devices for storing, as non-transferable computer readable storage media, data associated with a user's profile, preferences, and/or other user data. The database 104 may be communicably coupled to the user device 102 and controller 108. User profile data may include a user's identification information, such as name, date of birth, address, driver's license number, passport number, and/or other identification information. User profile data may include payment information, such as credit card information and an associated billing address. Such identification and payment information may be input by a user, or may otherwise be captured or received, as part of a user onboarding process, as described for example in U.S. patent application Ser. No. ______, entitled “Systems and Methods for Creating and Maintaining a Secure Traveler Profile for Curating Travel Itineraries,” and filed on Feb. 12, 2019, the content of which is hereby incorporated by reference herein in its entirety. In some embodiments, user profile data may also include loyalty program information or rewards membership information that relates to a particular hotel, airline, or other transportation company.

User profile data may additionally include a user's travel preferences, such as preferred travel service providers. Preferences may further include flight or air transportation preferences, such as a preference for particular flight times, a preference for a minimum or maximum number of stops or length of layovers, a preference for seat selection or seat class, and/or other flight preferences. Preferences may include hotel or overnight accommodation preferences, such as a preference for room type or size. As a particular example, a user may prefer a room with a view where available, or a user may prefer a kitchenette when a stay will be longer than two nights. Other travel preferences may include preferences regarding length of stay. For example, one user may prefer to fly in the morning of a meeting where possible, while another user may prefer to fly in the day before a meeting. Preferences may include rental car or ground transportation preferences, such as a preferred size or type of vehicle. Preferences may additionally include cost preferences, such as maximum airfare, overnight accommodation cost, ground transportation cost, or other cost preferences. In some embodiments, preferences may include company or corporate preferences, restrictions, or limitations. For example, a user's company may have a policy for a maximum airfare cost. The user profile data may include a preference reflecting this maximum airfare cost. Other travel preferences are contemplated as well. Travel preferences may be entered by a user, such as during the onboarding process or thereafter. However, in some embodiments, travel preferences may be determined or adjusted based on a user's travel selections. For example, where a user routinely selects recommended travel itineraries with morning flights, a user preference for morning flight times may be created and stored in the database 104.

User profile data may include a user's travel priorities, which may include rankings or importance settings for various travel parameters or preferences. That is, stored priorities may indicate how important particular parameters or preferences are for a user. Priorities may help to evaluate or select suitable travel services for a user. For example, user priorities may include rankings or importance settings for or related to cost, timing, number of flight stops or other air transportation parameters, airport or hotel distance, hotel amenities or other overnight accommodation parameters, or ground transportation parameters.

Each travel provider database 106 may include one or more local or remote data storage devices for storing, as non-transferable computer readable storage media, searchable travel service data. In some embodiments, a travel provider database 106 may be a third-party database. A travel provider database 106 may be associated with a single service provider. For example, a travel provider database 106 may be a Delta database providing searchable flight information for Delta flights. Such databases may be provided and/or maintained by the individual service providers. In some embodiments, a travel provider database 106 may include searchable data for a plurality of service providers. For example, a database 106 may be provided and maintained by Hotels.com, Travelocity, Trivago, Kayak, Expedia, Hotwire, and/or other third-party travel booking sites or companies. In some embodiments, a travel provider database 106 may be a database provided and maintained by Sabre Corporation. Each travel provider database 106 may be communicably coupled with the user device 102 and the controller 108.

The user profile module 110 may include hardware and/or software for receiving, maintaining, and updating user information stored in the database 104. In particular, the user profile module 110 may include hardware and/or software for receiving, maintaining, and updating user identity data, payment data, user preferences and priorities, and the user's historical itinerary selections. The user profile module 110 may further include hardware and/or software for facilitating user onboarding and profile building, as described in U.S. patent application Ser. No. ______, entitled “Systems and Methods for Creating and Maintaining a Secure Traveler Profile for Curating Travel Itineraries,” and filed on Feb. 12, 2019, previously fully incorporated herein by reference.

In some embodiments, the calendar module 112 may include hardware and/or software for communicating with a calendaring application or program to receive calendar entry notifications indicating when a user has created a new calendar entry and event data corresponding with the calendar entry. In other embodiments, the calendar module 112 may include hardware and/or software for providing the user with a calendaring interface via the user device 102 through which the user may directly create calendar entries and input event details. The calendar module 112 may further be configured with hardware and/or software to extract travel parameters from calendar event details. For example, the calendar module 112 may analyze event details to determine whether an event includes or requires travel, whether airplane, train, bus, or other travel modes may be suitable, whether overnight accommodations may be required or desired, and/or whether a car service, rental car, or other ground transportation service may be desired or required. Additionally, the calendar module 112 may analyze event details to determine suitable arrival and departure times and dates, hotel and airport locations, bus or rail station locations, whether overnight accommodations may be needed, whether a rental car or car service may be needed, and/or other travel parameters.

The travel itinerary module 114 may include hardware and/or software for applying travel parameters, user preferences, and/or user priorities to curate one or more suitable travel itinerary suggestions. In particular, the travel itinerary module 114 may be configured to searching the one or more travel provider databases 106 using travel parameters. Travel parameters may be extracted from event data by the calendar module 112, as described above. Travel parameters may additionally be created or modified by the travel itinerary module 114 based on user preferences. For example, the travel itinerary module 114 may create a travel parameter based on a user preference for particular overnight amenities (i.e., room service, city view, continental breakfast, etc.). The travel itinerary module 114 may additionally or alternatively modify travel parameters based on user preferences. For example, where a stored user preference indicates that the user prefers morning flights, parameters related to arrival time and departure time may be modified to designate morning flight times. The travel itinerary module 114 may further be configured to apply stored user priorities. For example, the travel itinerary module 114 may apply user priorities to travel parameters as weighted coefficients to designate importance of some parameters. In other embodiments, the travel itinerary module 114 may apply or accommodate user priorities in other ways. The travel itinerary module 114 may further be configured to search the one or more travel provider databases 106 using the travel parameters, as determined from event details and user preferences and as adjusted or weighed by the user priorities.

The travel itinerary module 114 may further be configured to curate one or more travel itinerary suggestions to include suitable travel services. In particular, the travel itinerary module 114 may be configured to select travel services from the one or more travel provide databases 106 that correspond with or generally satisfy the applicable travel parameters, user preferences, and/or user priorities. The travel itinerary module 114 may combine different travel services (such as air transportation, overnight accommodations, ground transportation, and/or other travel services) to create a tailored travel itinerary to meet the user's travel needs. Additionally, the travel itinerary module 114 may be configured for presenting the one or more curated travel itineraries to a user via the user device 102 such that a user may edit, alter, select, or confirm an itinerary.

The booking module 116 may include hardware and/or software to facilitate booking one or more travel services. In some embodiments, where a user selects a suggested travel itinerary, the booking module 116 may be configured to automatically schedule and/or purchase the one or more travel services included in the itinerary. In particular, the booking module 116 may use stored identity data and payment data for the user to book and purchase the selected travel services from the service providers. The booking module 116 may ask the user, via the user device 102, to confirm or finalize the booking. In other embodiments, the booking module 116 may facilitate booking travel services by prompting the user to enter identity information and/or payment information. In other embodiments, the booking module 116 may facilitating booking travel services by connecting or linking the user to one or more service provider platforms where the user may book the services. In still further embodiments, the booking module 116 may automatically book travel services for the user.

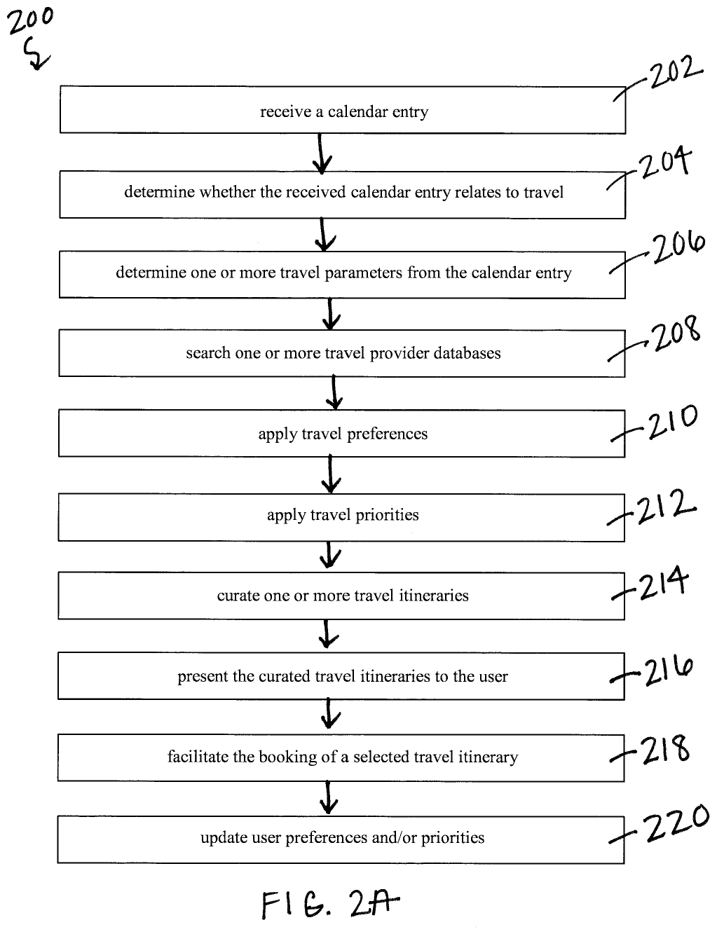

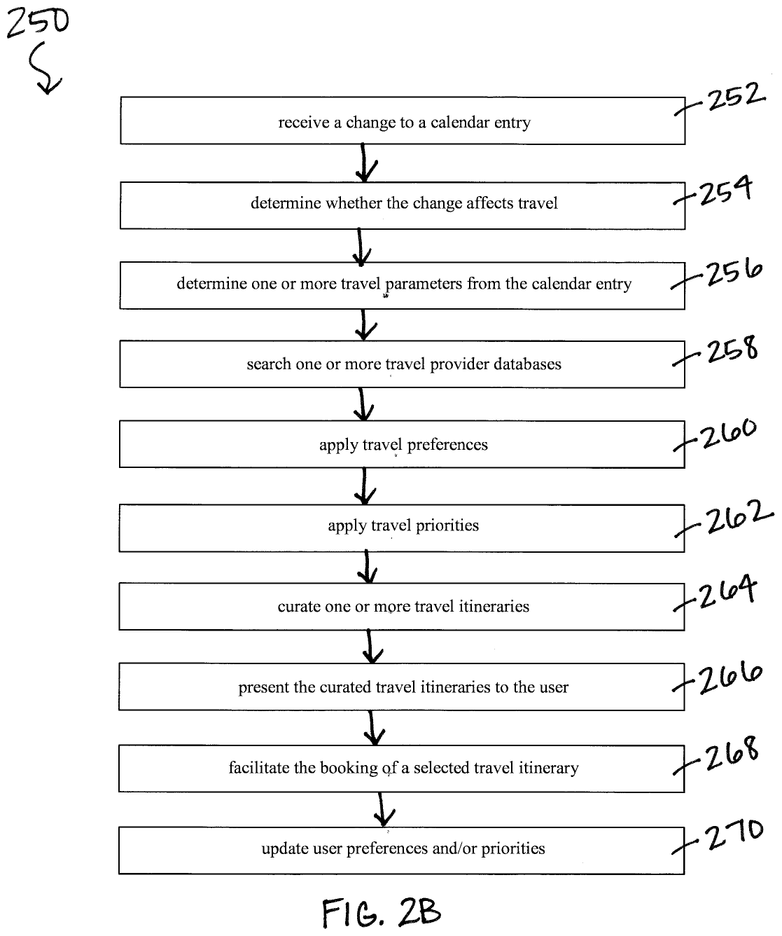

Turning now to FIG. 2A, a method 200 for booking travel, which may be performable or executable via a system of the present disclosure, is shown according to one or more embodiments. The method 200 may include the steps of receiving a calendar entry 202; determining whether the received calendar entry relates to travel 204; determining one or more travel parameters from the calendar entry 206; searching one or more travel provider databases 208; applying the user's travel preferences 210; applying the user's travel priorities 212; curating one or more travel itineraries 214; presenting the curated travel itineraries to the user 216; facilitating the booking of a selected travel itinerary 218; and updating the user's preferences and/or priorities 220. In other embodiments, the method 200 may include additional or alternative steps.

Receiving a calendar entry 202 may include receiving event data, such as an event time, location, and duration directly from a user via a user interface. In other embodiments, the calendar entry may be received from another application, program, or system. In some embodiments, receiving a calendar entry may include pinging or querying another application, program, or system to determine whether a new calendar entry was made by the user. The calendar entry may be an entry made by a user. For example, the user may create a new calendar entry and add details, such as time, location, and duration. In some embodiments, the calendar entry may be, or may relate to, an invitation the user receives for attending a meeting or event. In some embodiments, receiving a calendar entry may require integration with a calendar application, such as Outlook, Google Calendar, and other calendar applications. In some embodiments, the system may communicate with a user's calendar application via a mail server and/or calendar server associated with the user's calendar application, and then using a network-based connection to the mail server and/or calendar server to access the user's calendar and receive the calendar entry. In some embodiments, the system may integrate with the user's calendar application using an application programming interface specific to, or compatible with, the user's calendar application. In at least one embodiment, the system may be integrated with multiple calendar applications. The user may grant access to one or more calendar applications. In some embodiments, receiving a calendar entry may involve importing a first capture of the user's entire calendar into a database at a first time and then importing a second capture of the user's entire calendar into the database at a second time after a time interval has elapsed. In some embodiments, the time interval may be minutes. In some embodiments, the time interval may be less than a minute. In some embodiments, the time interval may be less than ten seconds. In some embodiments, the time interval may be less than a second. The first capture and the second capture may then be compared to determine whether a new calendar entry has been made or an existing calendar entry has been changed. In some embodiments, the system may push a trigger or alert, either via the application programming interface or a direct connection to the user's server, to identify that a change has been made to the user's calendar prior to receiving the calendar entry itself In still other embodiments, the system may include a “add-in,” “plug in”, or other utility program that is directly integrated into the user's calendar application to receive calendar entries. Rather than receiving the information from the user's calendar application, in some embodiments the calendar entry may be received from information stored within the user's operating system, mail server, text messaging system, social media platform, file sharing platform, messaging platform, software-based collaboration tool, or other application or program separate from the user's calendar application. In some embodiments, the calendar entry may be received via information associated with posts or exchanges of messages among users who are members of a team or group on a collaborative platform like Slack, Microsoft Teams, or Google Hangouts. In still another embodiment, the system may automatically receive the calendar entry by the user sending the calendar entry to the system just like a user might add another attendee to a calendar entry. For example, the system may have an email address to receive calendar entries, and the user may input the email address as an “attendee” to the calendar entry for the system to automatically receive the calendar entry initially and all updates to the calendar entry without comparing a capture of the user's entire calendar to a previously retrieved capture of the user's entire calendar.

Determining whether the received calendar entry relates to travel 204 may include receiving an express indication from a user that the calendar entry relates to, or requires, travel. For example, in some embodiments, the method may include, upon determining a user is making or has made a new calendar entry, asking the user via the user interface whether the new calendar entry relates to or requires travel. In other embodiments, a system of the present disclosure may evaluate event data associated with the calendar entry to determine whether the user will likely desire travel services to attend the event. In one embodiment, an event location associated with the calendar entry may be compared with the user's location, which may be previously identified or may be determined based on geolocation of the user's device. If the comparison shows that the event location for the calendar entry includes a different city or state than the user's location, for example, it may be determined that the user may desire travel services. In other embodiments, if the event location is outside of a predefined radius or distance from the user's location, such as more than 200 miles, 300 miles, or 400 miles for example, it may be determined that the user may desire travel services. In some embodiments, after automatically determining that the user may benefit from travel services to attend the event, the method may include asking the user to confirm whether the event is a trip or whether the user would like travel service recommendations.

Determining travel parameters from the calendar entry 206 may include extracting trip details from the calendar entry that may be used to search for suitable travel services. In particular, the received event location, time and date, duration, and/or other event data may be analyzed to determine travel parameters such as arrival time and date, departure time and date, closest airports, number of overnights, whether a rental car or car service may be needed, and/or other travel parameters. For example, an event location may be parsed to determine a destination city for the user's event. In some embodiments, the event location may be compared to known airport locations to determine one or more suitable airports into which the user may wish to fly to reach the event. The start time, end time, and/or duration of the event may be analyzed to determine suitable arrival and/or departure dates and times for the event. For example, where the calendar entry includes an out-of-town meeting beginning at 8 AM, suitable arrival times may include any flights arriving by at least 7 AM or flights arriving the prior evening. When determining suitable arrival and departure times, a time buffer of, for example, at least one hour or at least two hours may be included around calendar entry start and end times. Additionally, in some embodiments, estimated drive times, traffic patterns, weather, Transportation Security Administration (TSA) wait times, and/or other information that may affect travel may be taken into consideration when determining suitable arrival and departure times. Event times and/or duration may additionally be analyzed to determine whether overnight accommodations may be needed and further to determine how many overnights. For example, where the event includes a two-day conference, it may be determined that a one-night or two-night stay may be needed depending on available flights. In some embodiments, determining travel parameters may include determining whether a trip includes multiple stops or destinations, as described for example in U.S. application Ser. No. ______, entitled “Systems and Methods for Multi-Destination Travel Planning Using Calendar Entries,” and filed on Feb. 12, 2019, the content of which is hereby incorporated by reference herein in its entirety.

Searching travel provider databases 208 may include accessing one or more travel provider databases containing air transportation, overnight accommodations, ground transportation, and/or other travel services. Such databases may be searched using travel parameters extracted from event data. For example, parameters such as time and date of arrival and departure may be selected based on event data for the calendar entry. Airport and hotel location parameters, or other location parameters, may be based on event data. Additionally, based on the event data, it may be determined whether a rental car or other ground transportation is needed. Once search results are obtained, the user's travel preferences and/or priorities may be applied to narrow the results so as to select appropriate travel services for a curated itinerary.

Applying the user's travel preferences 210 may include narrowing search results from step 208 based on predefined or predetermined user preferences related to air transportation, overnight accommodations, ground transportation, and/or other travel preferences. Travel preferences related to flights or other air transportation may include preferred airlines, flight times, preferences related to layovers or stops, preferences related to seat availability or selection, or seat class. Other air transportation preferences may include preferences related to when or how a user prefers to travel. As a particular example, a user's flight preference may include that, when the user has a morning out-of-town meeting, the user prefers to arrive the night before the meeting. As another particular example, a flight preference may include that a user prefers to arrive at an airport at least three hours prior to a flight. Travel preferences related to overnight accommodations may include preferred hotel brands or locations, room type or size, hotel star rating, amenities, check-in or check-out times, or other overnight accommodation preferences. Ground transportation preferences may include circumstances under which a user prefers to rent a car or prefers to rely on public transportation, taxis, ride shares, or black car services. As a particular example, a user may prefer to rent a car when the user plans to be in town for more than one night or where the user has more than one meeting or event at the destination. Ground transportation preferences may additionally include preferred car rental companies, vehicle sizes or types, vehicle options, or other preferences. In some embodiments, ground transportation preferences may include preferences related to rails or trains, subways, buses, ferries, boats, and/or other forms of ground transportation. Other user preferences may relate to costs. For example, a user may set a maximum cost or a cost range for airfare, hotel, and/or car services or car rental.

Applying the user's travel priorities 212 may include narrowing search results from step 208 based on predefined or predetermined user priorities related to air transportation, overnight accommodations, ground transportation, and/or other travel services. The user's travel priorities may indicate or rank the importance of particular parameters or factors. For example, a user may indicate that price is a most important travel parameter or that the user is particularly price conscious. As another example, a user may indicate that the availability of non-stop flights is a most important or particularly important travel parameter. As another example, a user may indicate that hotel distance is not a high priority for the user. In some embodiments, the user's priorities may be applied to travel parameters as weighted coefficients to help search for and/or select appropriate travel services to match the user's preferences.

It is to be appreciated that in some embodiments, at least a portion of the user's travel preferences and/or priorities may be applied to modify or adjust travel parameters prior to searching travel provider databases. For example, parameters such as time and date of arrival and departure may be selected based on event data for the calendar entry, but may be modified based on user preferences. Parameters related to a maximum number of flight stops or length of layovers, seat class, seat selection, and/or other air transportation parameters may input to the search based on user preferences. Airport and hotel location parameters, for example, may be based on event data, but modified prior to or during the search based on applicable user preferences. Parameters reflecting desired overnight amenities, star rating, brand, and/or other overnight accommodation parameters may be added to the search based on user preferences. Additionally, based on the event data, it may be determined whether a rental car or other ground transportation is needed. The user's stored preferences related to type or brand of rental car, or other rental car preferences, may be used to modify or add rental car parameters. User preferences related to cost of various travel services or total itinerary cost may be used to input cost parameters for the search. Additionally, user priorities may be used to weigh the travel parameters appropriately. For example, where a user indicates high importance for total cost, one or more cost parameters may be assigned a relatively high coefficient value. Similarly, where a user indicates that total cost is unimportant, one or more cost parameters may be assigned a relatively low coefficient value. Moreover, in some embodiments, travel provider databases may be searched more than once to accommodate user preferences and/or priorities. For example, a first search may be performed based on travel parameters selected from the calendar entry, and a second search may be performed to include user preferences and/or priorities.

Based on search results and the user's travel preferences and priorities, one or more itineraries may be curated 214 to include air transportation, overnight accommodations, ground transportation, and/or other travel services. A suitable travel itinerary may include, for example, flight, hotel, and rental car information that best meets a user's preferences and priorities. Where there are multiple travel service options that may satisfy the travel parameters, as well as the user's preferences and priorities (such as, for example, alternate flights or alternate hotel reservations), alternate itineraries may be curated to present to the user as options. It is to be appreciated that in some embodiments, itineraries or alternate itineraries may be built based on travel services that most closely align with the parameters, user preferences, and user priorities, even where such parameters, preferences, and priorities may not be entirely satisfied in each case.

The one or more curated travel itineraries may be presented to the user 216 via the user interface. Each itinerary may include a grouping of travel services suitable for a particular calendar entry or for a particular trip. For example, a travel itinerary may include departing and returning flight information, hotel information, and/or car service or car rental information. Where a trip does not include an overnight stay, the itinerary may be presented without the need for hotel information. Where alternate itineraries are presented, some itineraries may include different services than others. For example, a first alternate itinerary may include a next-day flight, and may require an overnight stay such that the itinerary includes hotel information, while a second alternate itinerary may include a day-of flight, and thus may not require the overnight stay and may not include hotel information. In some embodiments, a maximum of two or three alternate itineraries may be presented to the user. The user may additionally have an option to request different or additional itinerary options if, for example, the user is not satisfied with the options presented. The itinerary options may be presented with a total price for all of the travel services included in the itinerary and/or may present a price breakdown of the individual travel services. Itineraries may be presented as selectable icons, links, or options from which the user may indicate the user's choice.

In some embodiments, the method 200 may include booking travel based on the user's selected itinerary 218. In some embodiments, where the user's payment information and identity information is stored, the travel services associated with the user's selected itinerary may be purchased and scheduled automatically. In some embodiments, the user may be requested to confirm the booking and/or finalize some details for the booking. In other embodiments, where a user selects an itinerary, the user may be taken to a booking page where the user may input identity and payment information to book and purchase the one or more travel services for the itinerary.

In some embodiments, the user's stored preferences and/or priorities may be updated based on the user's selected itinerary 220. For example, where a user selects an itinerary having a higher total price than other itineraries but having non-stop flights, the user's stored preferences may be updated to reflect that the user may prefer non-stop flights and the user's stored priorities may be updated to reflect that the user may prioritize non-stop flights over cost. In some embodiments, the user may be asked to confirm whether the user's stored preferences and/or priorities should be amended or updated based on the selected itinerary.

In some embodiments, in addition to analyzing new calendar entries, systems of the present disclosure may be configured to recognize and respond to a modification to a calendar entry or, for example, deletion of a calendar entry. FIG. 2B shows one embodiment of a method 250 of responding to a change in a calendar entry. In particular, the method 250 may include the steps of receiving a change to a calendar entry 252; determining whether the change affects travel 254; determining one or more travel parameters from the calendar entry 256; searching one or more travel provider databases 258; applying the user's travel preferences 260; applying the user's travel priorities 262; curating one or more travel itineraries 264; presenting the curated travel itineraries to the user 266; facilitating the booking of a selected travel itinerary 268; and updating the user's preferences and/or priorities 270.

Receiving a change to a calendar entry 252 may include receiving an indication that a user has modified a calendar entry. For example, the user may have modified a meeting time, date, location, or duration. In some embodiments, receiving a change to a calendar entry may include receiving an indication that a user has removed or deleted a calendar entry. In some embodiments, where a calendar entry is modified via a calendaring application or program, information from the calendaring application or program may be communicated automatically to a system of the present disclosure. In other embodiments, receiving a modification to a calendar entry may include pinging or querying another application, program, or system to determine whether a calendar entry was modified.

The method 250 may additionally include determining whether the change to the calendar entry affects travel 254. For example, it may be determined whether the change is a change in time, duration, date, location, or another parameter that may affect associated travel services. In some embodiments, the change may cause a new need for travel services. For example, a meeting may initially be scheduled to take place locally, and may thereafter be rescheduled to take place in a different location requiring travel. Thus, upon the change in location, it may be determined that the calendar event, which did not previously require travel services, may now require transportation and/or other travel services. In some embodiments, the user may be asked to verify whether the change affects travel.

In some embodiments, the received change may lead to a cancelation of travel services. For example, where a meeting was initially scheduled to take place in another city, but is rescheduled to take place locally, it may be determined that travel services are no longer needed to attend the meeting. Likewise, where the received change is a cancelation or deletion of the calendar entry, it may be determined that travel services previously associated with the calendar entry are no longer needed. Where it is determined that travel services are no longer needed due to a change in a calendar entry, a notification may be sent to the user to verify that the travel services are no longer needed.

If it is determined that the received change to the calendar entry affects travel, travel parameters may be determined (or revised) for the calendar entry based upon the change 256. Additionally, travel provider databases may be searched based upon the determined (or revised) parameters, and travel preferences and priorities may be applied, as those steps are described above. In this way, it is to be appreciated that steps 256-270 of the method 250 may be similar to steps 206-220 described above with respect to FIG. 2A.

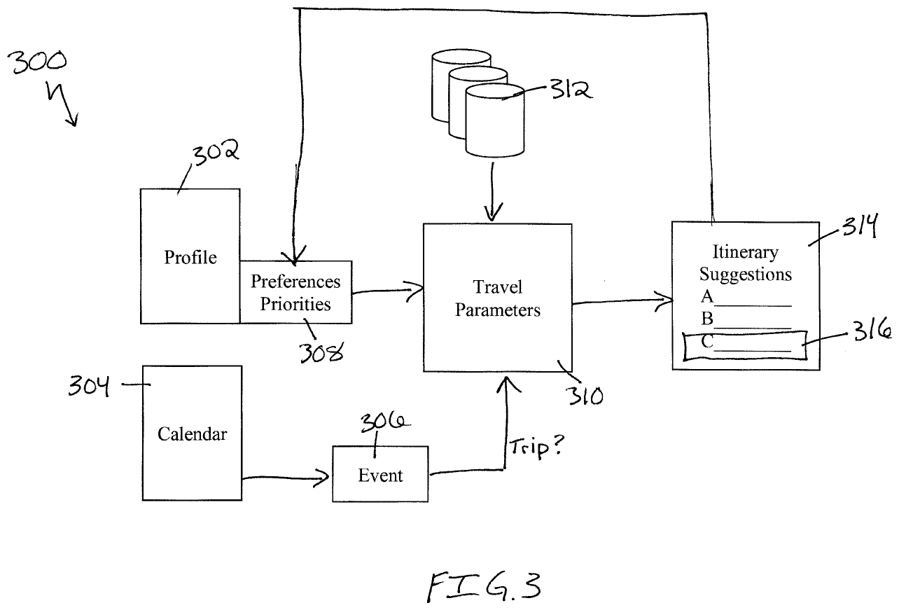

Turning now to FIG. 3, a system data flow 300 of the present disclosure is shown, according to one or more embodiments. As shown, a user may generally have a profile 302 and a calendar 304. The profile 302 may include user preferences and priorities 308, as described above. The profile 302 may additionally include user identity and payment information in some embodiments. In some embodiments, the profile 302 may include information retrieved directly from the user. In some embodiments, the profile 302 may include information about the user retrieved only from third party databases associated with the user from payment sources, loyalty programs, and/or other accounts associated with the user. In some embodiments, the profile 302 may include information about the user retrieved indirectly from third party databases based on inputs or other electronic activity by the user. The calendar 304 may include event data for calendar entries created by the user, by other individuals, and/or by other applications or programs. Event data may include start time and date, end time and date, duration, location, attendees, and/or other details. The profile 302 and calendar 304 may be maintained and/or provided via separate programs or applications, or may be provided and maintained by a single program or application.

As further shown in FIG. 3, when a user (or other source) creates an event 306 via the calendar 304, it may first be determined whether the event includes a trip or whether the user may benefit from one or more travel services to attend the event. The event 306 and user preferences and priorities 308 may be combined to develop travel parameters 310. The travel parameters 310 may be used to search one or more travel provider databases 312 for suitable travel services. Suitable travel services that meet or generally satisfy the travel parameters 310 may be combined into one or more travel itinerary suggestions 314, each of which may include one or more travel services. The itinerary suggestions 314 may be presented to a user such that a user may select a preferred itinerary 316 from the selections. Moreover, based on a user selection of a preferred itinerary 316, the user's preferences and priorities 308 may be updated to reflect any changes as a result of the user's selection.

In the present disclosure, improved systems and methods for booking, or facilitating the booking of, travel services have been described. The systems and methods described herein may help a user to more efficiently and easily schedule and purchase travel services for business or leisure travel. Systems and methods of the present disclosure may greatly reduce an amount of time and effort that a user may otherwise need to search for and book travel services through conventional means. Additionally, systems and methods of the present disclosure may provide a user with curated and individualized travel itineraries tailored to the user's particular preferences and priorities and scheduled to ensure the user reaches calendared meetings and events. Moreover, where the user has particular corporate or company travel restrictions, systems and methods of the present disclosure may be configured to accommodate such restrictions to ensure that the curated itineraries will be acceptable to the user's company.

Systems and methods of the present disclosure may provide for improvements in the field of travel planning, and particularly in the field of smart or automatic travel planning. In contrast to conventional travel planning systems and methods, systems and methods of the present disclosure may provide for a more efficient and tailored travel planning or booking process. By curating travel itineraries based on a user's calendar entries, a user's process for selecting and scheduling travel services may be greatly improved. Systems and methods of the present disclosure, or portions thereof, may be configured to operate automatically. For example, in some embodiments, a suggested travel itinerary may be presented to the user automatically after the user creates a calendar entry. Moreover, in some embodiments, a user need only confirm a suggested itinerary, and the travel services may be purchased and booked automatically. In still other embodiments, a user may grant pre-authorization or permission such that travel services may be booked automatically without user approval prior to each individual booking. It is to be appreciated that in such embodiments, travel services may be booked automatically without sending an itinerary to the user for approval or review. That is, in some embodiments, upon receiving a user's calendar entry, systems and methods of the present disclosure may operate to automatically search for appropriate travel services for the calendar entry, apply user preferences and/or priorities, develop a curated travel itinerary, and automatically book one or more travel services based on the user's pre-approval for such automatic transactions.

It is to be appreciated that systems of the present disclosure may be configured to learn or adjust for user preferences and priorities. That is, when a user makes a selection for a particular itinerary or for a particular travel service or group of travel services, systems of the present disclosure may record the user's selection and/or compare the user's selection to itineraries or services that the user did not select. As a particular example, where a user is presented with multiple itinerary suggestions, and the user selects (or routinely selects) itineraries or travel services having a relatively low cost as compared with other suggestions, the system may store a user preference or priority for low cost services. The system may then factor the preference or priority for low cost services into future suggestions. In this way, a system of the present disclosure may suggest more tailored recommendations over time based on the user's preferences and priorities as learned from previous user selections.

In some embodiments, systems and methods of the present disclosure may be configured to integrate with a voice command system or device. For example, systems and methods of the present disclosure may be configured for communication with an Amazon Echo device, a Google Home device, Apple HomePod device, or other smart home device or voice-activated device or system. For example, a user may create a calendar entry using such a device, and the device may communicate the calendar entry to a system of the present disclosure. In other embodiments, a user may instruct a smart home or other voice-activated device or system to search for, or book travel for, a particular event or date. Such instructions may be communicated from the smart home device to, for example, a controller of the present disclosure.

It is to be appreciated that systems and methods of the present disclosure may be configured to coordinate travel plans for multiple users simultaneously who may be attending one or more of the same events. In at least one embodiment, multiple attendees may be associated with the same calendar entry and travel may be coordinated and booked simultaneously based on the details of the calendar entry and the user's preferences and the group's preferences. It is to be appreciated that, in addition to a user's individual travel preferences and travel priorities, the systems and methods of the present disclosure may be used to determine group travel preferences and group travel priorities. The group travel preferences and group travel priorities may be compared to the user's individual travel preferences and travel priorities to curate one or more group travel itineraries for each user. The group travel itineraries may be the same for each of the users who are attendees of the same event, or they may differ depending on how the group travel preferences and group travel priorities compare to the user's individual travel preferences and travel priorities.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for providing a curated travel itinerary, the method comprising:
receiving a calendar entry for a user, the calendar entry comprising a location, date, and time;
determining whether the calendar entry relates to travel by comparing the location to a user location;
extracting one or more travel parameters from the calendar entry, the one or more travel parameters comprising at least one of arrival date, arrival time, departure date, departure time, and location;
searching a travel provider database using the one or more travel parameters, the travel provider database comprising searchable booking options for at least one travel service provider; and
building a curated travel itinerary for the calendar entry by selecting at least one booking option from the travel provider database.

2. The method of claim 1, further comprising modifying the travel parameters to reflect at least one stored user preference.

3. The method of claim 1, further comprising applying a weight to the one or more travel parameters based on at least one stored user priority.

4. The method of claim 1, further comprising presenting the curated travel itinerary to the user via a user interface.

5. The method of claim 4, further comprising building a plurality of curated travel itineraries for the calendar entry from which the user may make a selection.

6. The method of claim 5, further comprising receiving the user's selection of a preferred travel itinerary and automatically booking the travel services included in the preferred travel itinerary.

7. The method of claim 6, further comprising updating a stored user preference or a stored user priority based on the user's selection of a preferred travel itinerary.

8. The method of claim 1, wherein the user location comprises a stored location or a current geolocation for the user.

9. The method of claim 1, wherein extracting one or more travel parameters from the calendar entry comprises determining whether the calendar entry includes an overnight stay.

10. The method of claim 1, wherein the at least one travel service provider comprises an air transportation company, overnight accommodation company, or ground transportation company.

11. The method of claim 1, further comprising booking the at least one booking option of the curated travel itinerary using stored identity information and stored payment information for the user.

12. A system for providing a curated travel itinerary, the system comprising:
a database storing, as non-transferable computer readable storage media, at least one user travel preference;
a controller communicably coupled to the database and comprising:
a calendar module configured for receiving calendar entries from a calendaring application, and wherein upon receiving a calendar entry, the calendar module:
determines whether the calendar entry relates to travel by comparing a location associated with the calendar entry to a user location; and
extracts one or more travel parameters from the calendar entry, the one or more travel parameters comprising at least one of arrival date, arrival time, departure date, departure time, and location; and
a travel itinerary module configured for developing a curated travel itinerary based on the one or more travel parameters, and wherein upon receiving the one or more travel parameters from the calendar module, the travel itinerary module:
searches a communicably coupled travel provider database using the one or more travel parameters and the at least one user travel preference, the travel provider database comprising searchable booking options for at least one travel service provider; and
build a curated travel itinerary for the calendar entry by selecting at least one booking option from the travel provider database.

13. The system of claim 12, wherein the database further stores, as non-transferable computer readable storage media, at least one user priority and wherein the travel itinerary module searches the communicably coupled travel provider database using the one or more travel parameters, the at least one user travel preference, and the at least one user priority.

14. The system of claim 13, wherein the at least one user priority relates to travel cost.

15. The system of claim 12, wherein the database further stores, as non-transferable computer readable storage media, user identity information and user payment information, and wherein the controller further comprises a booking module configured to book the at least one booking option of the curated travel itinerary using the stored identity information and stored payment information.

16. The system of claim 12, further comprising a user interface accessible via a user device and wherein the travel itinerary module presents the curated travel itinerary to the user via the user interface.

17. A computer readable storage medium encoded with instructions that, when executed by a computer processor, cause the computer to:
upon receiving a calendar entry comprising a location, date and time, determine whether the calendar entry relates to travel by comparing the location to a user location;
extract one or more travel parameters from the calendar entry, the one or more travel parameters comprising at least one of arrival date, arrival time, departure date, departure time, and location;
search a travel provider database using the one or more travel parameters, the travel provider database comprising searchable booking options for at least one travel service provider; and
build a curated travel itinerary for the calendar entry by selecting at least one booking option from the travel provider database.

18. The computer readable storage medium of claim 17, wherein the instructions further cause the computer to modify the travel parameters to reflect at least one stored user preference.

19. The computer readable storage medium of claim 17, wherein the instructions further cause the computer to apply a weight to the one or more travel parameters based on at least one stored user priority.

20. The computer readable storage medium of claim 17, wherein the instructions further cause the computer to present the curated travel itinerary to the user via a user interface.
